(19) United States
(12) Patent Application Publication
(10) Pub. No.: US 2025/0318497 A1
(43) Pub. Date: Oct. 16, 2025

(54) Pet Accessory Device

(71) Applicant: Brandy Ponthieux, Brandon, FL (US)

(72) Inventor: Brandy Ponthieux, Brandon, FL (US)

(21) Appl. No.: 19/017,871

(22) Filed: Jan. 13, 2025

Related U.S. Application Data
(60) Provisional application No. 63/632,157, filed on Apr. 10, 2024.

(51) Int. Cl. A01K 1/035; A01K 1/01; A01K 5/01; A01K 15/02

(52) U.S. Cl. CPC A01K 1/0353; A01K 1/0107; A01K 5/0114; A01K 15/024

(57) ABSTRACT

A cat wall device is disclosed for easily storing and organizing cat supplies and accessories. The cat wall device comprises a body or base component that is configured in a rectangular shape or suitable shape known in the art. The body component can be manufactured in a plurality of different accessories, colors, and various indica. Further, the base component can be cleaned or changed to the users' desired preference. Moreover, the base component comprises a plurality of threaded holes to attach and adjust cat accessories. The base component secured to a wall or suitable flat vertical surface for use via brackets and screws. Further, the body component and accessories are easily installed, removed, and adjusted for convenience.

### CROSS-REFERENCE TO RELATED APPLICATION

The present application claims priority to, and the benefit of, U.S. Provisional Application No. 63/632,157, which was filed on Apr. 10, 2024, and is incorporated herein by reference in its entirety.

### FIELD OF THE INVENTION

The present invention relates generally to the field of pet accessory devices. More specifically, the present invention relates to an improved cat wall device for cats. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet accessory devices. Generally, cat owners have an assortment of cat accessories and toys strewn throughout their home. Further, whether it is a floor-based accessory or wall-based accessory, there are limited ways to repair or adjust due to damage or general wear and tear. Users need an easier and more convenient way to store and organize pet toys, leashes, apparel, or other accessories.

Further, current options for wall-based storage and organization require drilling multiple holes in the wall of the home or other stationary surface, making it difficult to rearrange the space without creating more holes in the wall. Moreover, options for floor-based cat accessory storage and organization cause additional clutter and disorganization in the living space or area. Specifically, creating a less attractive home environment aesthetically. Finally, the most common accessories, such as scratchers and beds, tend to experience excessive wear and tear, however, the whole accessory may not be damaged, therefore, forcing pet owners to throw out the entire system or attempt a DIY repair. Typically, interchangeable accessories and pieces and compatible accessories are not commonly available. Without a cat wall or similar device, the pet owner frequently incurs unforeseen costs.

Accordingly, there is a demand for an improved cat device that provides pleasure, storage and organization for a house cat and accessories. Further, there is a demand for a cat wall device that is easily installed with minimal damage to a wall or other stationary surface. More specifically, there is a demand for a device that is attractive and aesthetically appealing within the current home décor.

Therefore, there exists a long felt need in the art for a pet accessory device that provides owners of cats a tool to store and organize their pet's accessories. There is also a long felt need in the art for a device for cats to relax, play, and eat that is organized and orderly. There is also a long felt need in the art for a cat accessory storage device that comprises interchangeable accessories and pieces. Specifically, there is a long felt need in the art for a cat accessory storage device that is adjustable and accommodates a variety of enhancements and accessories with case. Further, there is a long felt need in the art for a cat accessory storage device that mounts easily to a wall or flat vertical surface with minimal damage to the wall or surface. Moreover, there is a long felt need in the art for a device that is attractive and can be designed to match the décor of the space. Finally, there is a long felt need in the art for a cat accessory storage device that is customizable via a plurality of different accessories, colors, and styles.

The subject matter disclosed and claimed herein, in one embodiment thereof, comprises a cat accessory storage device. The device is a multipurpose, cat wall designed for easily storing and organizing cat supplies, while providing leisure activities for a cat in a home or other suitable space. The cat wall device comprises a base or body component constructed of, for example, wood base or body configured in a rectangular shape (i.e., rectilinear) or suitable shape known in the art. The base or body component comprises a plurality of threaded holes throughout the wood base or body used to attach, detach, adjust, and move the various cat accessories. The base or body component can be cleaned or replaced with a variety of themes or colors. Further, the body component is easily secured to a wall or flat vertical surface with brackets. Finally, the body component can be easily removed from a wall or flat vertical surface and relocated to another wall or flat vertical surface.

In this manner, the cat wall device of the present invention accomplishes all of the forgoing objectives and provides users with a device that provides entertainment, storage, and organization for a cat and their accessories. The device has adjustable components for added features and accessories The device can be moved and is customizable.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cat wall device. The device is a multipurpose, cat wall easily storing and organizing cat supplies, while serving as an activity unit for a cat in a home or other suitable space. The cat wall device comprises a base component that can be manufactured in a variety of colors or indicia. The base component comprises a plurality of threaded holes used to attach cat accessories. The base or body component is secured to a wall or other flat vertical surface with brackets and fasteners. Further, the body component and accessories are easily adjusted and moved for convenience.

The present invention is directed to a cat wall device that has particular utility in storing and organizing cat accessories, while providing leisure apparatuses, such as climbing shelves, scratch pad or boards, cat tree, feeding stations, and other cat paraphernalia, etc. In the present invention, the cat wall device can be customized and adjusted to the pet owner or cat's desired comfort level. Although the device, in one embodiment, is secured to a wall or flat vertical surface, the device can be moved and configured to be secured to a floor to meet various pet needs and preferences. Accordingly, the cat wall device has interchangeable body components for a fresh new look and addons such as storage to hide cat litter, extra food, and unused accessories.

In one embodiment, the cat wall device comprises a base or body component that is configured in a rectangular shape, but can be any suitable shape and size as is known in the art. The base component comprises a top side, a bottom side, and at least one additional side. The base component is preferably manufactured from wood, such as pine or particle board, but could also be manufactured of another solid material (i.e., plastics), as well. The base component comprises a plurality of threaded holes which are arranged equal distance apart on the body component. Moreover, the base component is configured in a rectangular shape or any suitable shape and size. Further, the base component can be stained or painted using a pet friendly colorant. Finally, the base component can be covered in a woven fabric and a plurality of different accessories, colors, or indicia to match the design of the home or space.

In one embodiment, the base of the body component is covered in a woven fabric and secured to the base with a pet friendly adhesive or other suitable bonding agent. Preferably, the fabric cover is a woven durable fabric such as but not limited to microfiber, microsuede, tight weave fabrics, or any other suitable fabric as is known in the art. Specifically, the fabric cover is preferably snag resistant to avoid damage caused from cats clawing and scratching. A user can replace the fabric cover with new fabric or change the color or theme of the body component.

In one embodiment, the base or body component comprises a plurality of threaded holes positioned at an equal distance spanning the entire area of the body of the device. Specifically, threaded holes positioned at an equal distance provide for easy adjustment regarding the pet accessories and their placement. Further, the plurality of threaded holes can be any suitable size and shape as is known in the art. The base or body, in one embodiment, includes consistent pattern of threaded inserts throughout the base or body component, spaced evenly apart, to be used to secure any accessories desired on the base or body. The threaded holes allow for customization when designing the placement of existing accessories or with the addition of new accessories without having to replace an entire cat wall system.

In yet another embodiment, screws and bolts are used to attach the cat accessories to the cat wall. Preferably, the screws and bolts are manufactured from a metal material for durability. Moreover, the accessories provide support for weights up to 20 pounds, however, they can be manufactured to support varying weights based on a user's preference or a pet's weight.

In one embodiment, the cat wall device comprises a plurality of accessories that are attached to the device using screws and bolts. The accessories can be any suitable number and shape and size as is known in the art. Typically, the device comprises a variety of accessories and cat toys. In yet another embodiment, the device comprises at least one detachable climbing shelf, preferably manufactured from a wood material. Specifically, the climbing shelf is configured in a rectangular (i.e., rectilinear) shape with a top side and a bottom side. The top side of the climbing shelf lined with a durable pet friendly fabric, such as, but not limited to, jute or other suitable fabric known in the art.

In one embodiment, the cat wall device comprises a scratch pad or board. The scratch pad or board can be configured in a variety of shapes and sizes. The scratch pad or board is preferably made of, but not limited to, felt, polypropylene, or suitable pet friendly material. The scratch pad or board provides a soothing and calming feeling as cats gratify their scratching needs without damaging carpet, furniture, or other household items.

In one embodiment, the cat wall device comprises a cat tree. The cat tree can be configured in a cylindrical shape and covered with a durable snag resistant pet friendly woven fabric. The cat tree is yet another accessory that provides a calming and soothing sensation without a pet snagging or damaging furniture or carpet.

In one embodiment, the cat wall device comprises a nesting bed accessory. The nesting bed can be configured in a variety of shapes and sizes. Preferably, the nesting bed is manufactured from a natural material such as but not limited to wool, cotton, or bamboo. The nesting bed is another accessory that provides an area for a feline to nap or sleep without creating additional clutter in the space. Cats have sensitive noses, therefore, using natural materials are an optimal choice.

In one embodiment, the cat wall device comprises a feeding station. A feeding station can be configured in a variety of shapes and sizes. Preferably, the feeding station is manufactured from a lightweight, durable, pet friendly material such as but not limited to stainless steel or wood material. The feeding station is yet another accessory that provides an area for cats to cat. Further, it provides users with multiple pets a means to feed each pet separately, without the worry of the pets eating each other's food. Specifically, when pets require a special diet or medication, users can feel confident their other pets will not ingest the food or medication meant for another pet.

In one embodiment, the cat wall device comprises a storage container. The storage container can be configured in a variety of shapes and sizes. The storage container is yet another accessory that provides decorative storage to hide additional cat food or cat litter. Further, the storage container may also store unused accessories for the base or body.

In yet another embodiment, the call wall device comprises a litter box. A litter box can be configured in a variety of shapes and sizes. Preferably, the litter box is manufactured from a lightweight durable plastic material that can be easily cleaned. The litter box is yet another accessory that provides an area for cats to relieve themselves. Further, it allows users with multiple pets or cats to provide separate litter boxes. Finally, an elevated litter box ensures other pets or toddlers cannot access the litter and ingest the contents, causing potential harm or injury.

In another embodiment, the cat wall device is secured to a wall or flat vertical surface using at least one bracket with at least one opening. Preferably, the bracket is manufactured in an L-Shaped configuration from a sturdy metal material, such as but not limited to steel or aluminum. Finally, the bracket can be manufactured in any suitable size and material to accommodate the desired weight and level of support required for the cat wall system.

In yet another embodiment, the cat wall device comprises a plurality of indicia. Users of the device can replace or change the fabric insert or color of the insert to coordinate with the décor of their home or space where the device is located.

In yet another embodiment, a method of easily storing, organizing, and customizing the cat wall device is included. The method includes the steps of providing the cat wall device with a plurality of holes, fabric covering, and adjustable accessories. The method also comprises securing the desired accessories in a selectable space on the body component via screws and bolts. Further, the method comprises securing the device to a wall or suitable flat vertical surface. The method also comprises adjusting or moving the accessories to desired location. Finally, the method comprises removing the fabric insert cover to wash, replace or change.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cat wall system device of the present invention in accordance with the disclosed architecture;

FIG. 2 illustrates a perspective view of one embodiment of the cat wall system device of the present invention showing how the accessories are mounted to the device in accordance with the disclosed architecture;

FIG. 3 illustrates a perspective view of one embodiment of the cat wall system device of the present invention showing how the bolts are secured in accordance with the disclosed architecture;

FIG. 4 illustrates a perspective view of one embodiment of the cat wall system device of the present invention showing the device mounted on a wall in accordance with the disclosed architecture;

FIG. 5 illustrates a perspective view of one embodiment of the cat wall system device of the present invention showing the entire design of the device mounted in accordance with the disclosed architecture; and

FIG. 6 illustrates a flowchart showing the method of easily mounting and utilizing the device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a pet accessory device that provides owners of cats a tool to store and organize their pet's accessories. There is also a long felt need in the art for a cat accessory storage device that comprises interchangeable accessories and pieces. Specifically, there is a long felt need in the art for cat accessory storage device that is adjustable and accommodates a variety of enhancements and accessories with case. Further, there is a long felt need in the art for a cat accessory storage device that mounts easily to a wall or flat vertical surface with minimal damage to the wall or surface. Moreover, there is a long felt need in the art for a device that can be designed to match the decor of the space. Further, there is a long felt need in the art for a cat accessory storage device that is customizable via a plurality of different accessories, colors, and styles. Finally, there is a long felt need in the art for a cat system that provides storage, organization, and is easily relocated for convenience.

The present invention, in one exemplary embodiment, is a cat wall storage and organization device. The cat wall device comprises a body or base component that is configured in a rectangular shape or suitable shape. The base component comprises a plurality of threaded holes and is secured to a wall or flat vertical surface with at least one bracket with at least one opening using a fastener, such as but not limited to a screw. The base component can be removed, cleaned or changed for a fresh new appearance. The present invention also includes a novel method of easily organizing and adjusting cat accessories in the home. The method includes the steps of providing a cat wall device comprising a body or base component with a plurality of threaded holes and adjustable accessories. The method also comprises securing the desired accessories to the body component via screws and bolts. Further, the method comprises securing the device to a wall or flat vertical surface using brackets and fasteners. The method also comprises adjusting and moving the cat accessories. Finally, the method comprises removing the accessories to clean, replace, change, or move the base component for an updated fresh look.

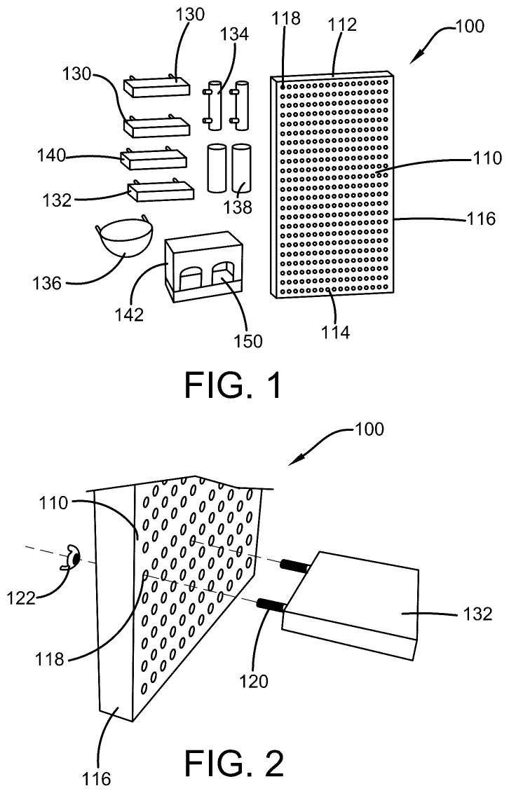

Referring initially to the drawings, FIG. 1 illustrates a perspective view of one embodiment of the cat wall device 100 of the present invention. In the present embodiment, the cat wall device 100 is an improved cat wall device 100 that provides a user with a multipurpose, cat wall for storing and organizing feline accessories. Specifically, the cat wall device 100 comprises a body or base component 110 with a top side 112, a bottom side 114, at least one additional side 116, threaded holes 118, and a plurality of cat accessories. The base component 110 comprises a plurality of threaded holes 118, used to attach cat accessories. Further, the device 100 comprises a base component 110 which can be cleaned or replaced.

Generally, the present invention is directed to a cat wall device 100 that has particular utility in storing and organizing cat accessories, such as climbing shelves 130, scratch pads or boards 132, cat trees 134, nesting beds 136, massagers 138, hammocks 140, peek a boo houses 142, and toys 144. In the present invention, the cat wall device 100 provides a feeding station 150, litter box 152, and storage 154 for convenience and organization. Accordingly, the cat wall device 100 allows for users to easily store and organize cat accessories, reducing the clutter than can be created in the home or space.

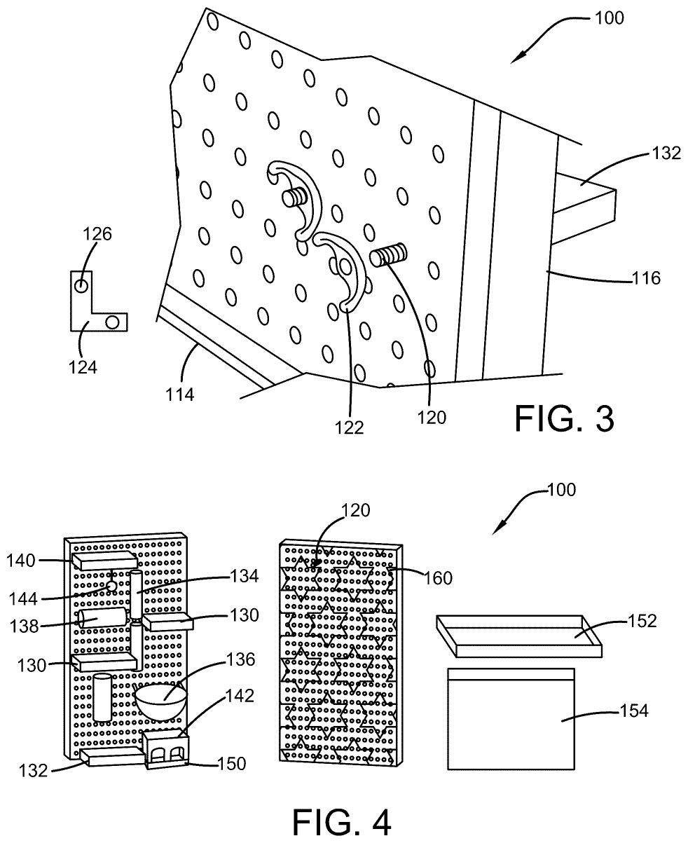

As shown in FIGS. 2-3, the cat wall device 100 comprises a body or base component 110 that is configured in a rectangular shape, but can be any suitable shape and size as is known in the art. The body component 110 comprises a plurality of threaded holes 118 to secure cat accessories, such as a scratch pad 132 to the device 100 via screws or bolts 120 and nuts 122. The base component 110 is typically wood, such as pine or particle board, but could also be manufactured of a durable material, as well. The base component 110 comprises a plurality of threaded holes 118 which are configured in a consistent pattern and span across the entire surface of the device 100. Thus, the base component 110 size, screw or bolt 120 size, and nut 122 size can be adjusted to support varying weights. Further, the body component 110 can be easily repositioned to a different or more desirable location using a bracket 124, with at least one opening 126 and at least one screw or bolt 120.

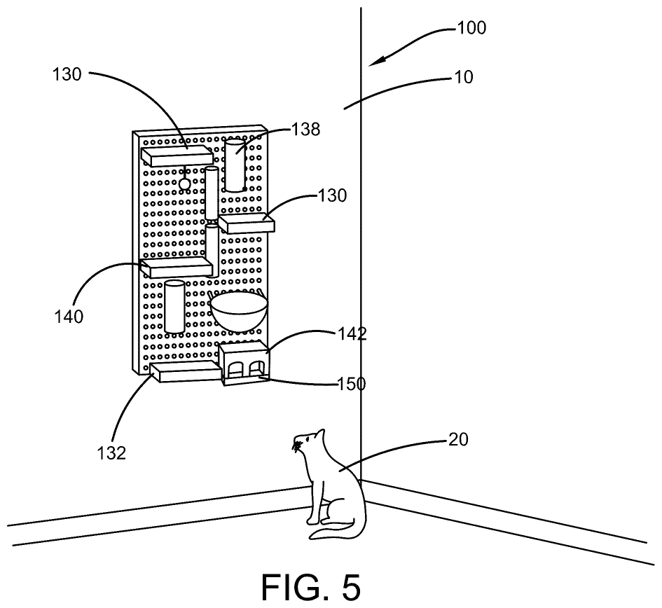

As shown in FIGS. 4-5, the cat wall storage and organization device 100 comprises a plurality of accessory configurations that are secured via screws or bolts 120 and nuts 122. The placement and configuration of the climbing shelves 130, scratch pad 132, cat tree 134, nesting bed 136, massager 138, hammock 140, peek a boo house 142, toys 144, feeding station 150, litter box 152, and storage container 154 can vary and be adjusted to the user's and the cats' preference. Typically, the device 100 is configured in a rectangular shape. Further, the device 100 body component 110 can be any suitable shape and size as is known in the art. Moreover, the body component 110 can be manufactured in a plurality of indica 160 to match the design of a home or other space. Finally, providing users the ability to adjust accessories, relocate the device 100 and change the base component 110 with another color or indica 160 is appealing to many pet owners, as well as cats.

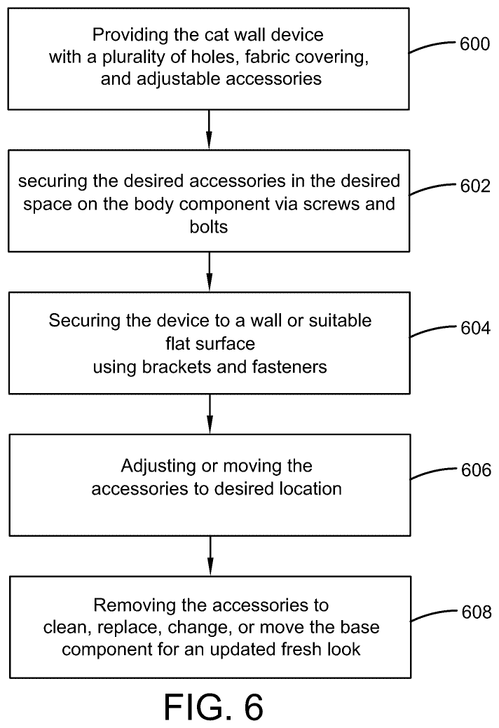

FIG. 6 illustrates a flowchart of the method of easily organizing and adjusting cat accessories in the home. The method includes the steps of at 600, providing the cat wall device with a plurality of holes, fabric covering, and adjustable accessories. The method also comprises at 602, securing the desired accessories in the desired space on the body component via screws and bolts. Further, the method comprises at 604, securing the device to a wall or suitable flat vertical surface using brackets and fasteners. The method also comprises at 606, adjusting or moving the accessories to desired location. Finally, the method comprises at 608, removing the accessories to clean, replace, change, or move the base component for an updated fresh look.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cat wall device”, “cat wall system device”, “storage and organization device”, and “device” are interchangeable and refer to the cat wall device 100 of the present invention.

Notwithstanding the forgoing, the cat wall device 100 of the present invention can be of any suitable size and configuration as is known in the art without affecting the overall concept of the invention, provided that it accomplishes the above stated objectives. One of ordinary skill in the art will appreciate that the cat wall device 100 as shown in FIGS. 1-6 is for illustrative purposes only, and that many other sizes and shapes of the cat wall device 100 are well within the scope of the present disclosure. Although the dimensions of the cat wall device 100 are important design parameters for user convenience, the cat wall device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cat wall device comprising:
a base component having a top side, a bottom side, at least one additional side, and a plurality of holes;
a plurality of bolts;
a plurality of nuts;
a plurality of cat accessories;
a feeding station; and
a litter box;
further wherein each of said plurality of cat accessories mounted to said base component with a selected number of bolts and a selected number of nuts secured to a selected number of holes of said plurality of holes.

2. The cat wall device of claim 1, wherein said plurality of cat accessories selected from the group consisting of a climbing shelf, a scratch pad, a cat tree, a nesting bed, a massager, a hammock, and a peek a boo house.

3. The cat wall device of claim 2, wherein said feeding station mounted to one side of said base component.

4. The cat wall device of claim 3, wherein said litter box mounted to another side of said base component.

5. The cat wall device of claim 4, wherein said plurality of holes are threaded holes.

6. The cat wall device of claim 5, wherein said base component is mounted to a stationary surface selected from the group consisting of a wall and a floor.

7. The cat wall device of claim 6, wherein said base component having a material of wood.

8. A cat wall device comprising:
a base component having a top side, a bottom side, at least one additional side, and a plurality of threaded holes;
a plurality of bolts;
a plurality of cat accessories; and
a feeding station;
wherein said plurality of cat accessories selected from the group consisting of a climbing shelf, a scratch pad, a cat tree, a nesting bed, a massager, a hammock, and a peek a boo house; and
further wherein each of said plurality of cat accessories mounted to said base component with a selected number of bolts secured to a selected number of holes of said plurality of threaded holes.

9. The cat wall device of claim 8, wherein said feeding station mounted to one side of said base component.

10. The cat wall device of claim 9 further comprising a litter box, wherein said litter box mounted to another side of said base component.

11. The cat wall device of claim 10 further comprising a plurality of nuts, wherein a selected number of nuts secured to said selected number of bolts for attaching said plurality of cat accessories to said base component.

12. The cat wall device of claim 11, wherein said base component is mounted to a stationary surface selected from the group consisting of a wall and a floor.

13. The cat wall device of claim 12, wherein said base component having a material of wood.

14. A method of organizing and mounting cat accessories to a cat wall, the method comprising the steps of:
providing a base component, a plurality of bolts, a feeding station, and a plurality of selectively attachable cat accessories, wherein said base component having a top side, a bottom side, at least one additional side, and a plurality of threaded holes;
securing said base component to a stationary flat vertical surface; and
selectively mounting a number of said plurality of selectively attachable cat accessories to said base component with a selected number of bolts secured to a selected number of holes of said plurality of threaded holes.

15. The method of organizing and mounting cat accessories to a cat wall of claim 14, wherein said plurality of selectively attachable cat accessories selected from the group consisting of a climbing shelf, a scratch pad, a cat tree, a nesting bed, a massager, a hammock, and a peek a boo house.

16. The method of organizing and mounting cat accessories to a cat wall of claim 15, wherein said feeding station mounted to one side of said base component.

17. The method of organizing and mounting cat accessories to a cat wall of claim 16 further comprising a litter box, wherein said litter box mounted to another side of said base component.

18. The method of organizing and mounting cat accessories to a cat wall of claim 17 further comprising a plurality of nuts, wherein a selected number of nuts secured to said selected number of bolts for attaching said plurality of selectively attachable cat accessories to said base component.

19. The method of organizing and mounting cat accessories to a cat wall of claim 18, wherein said base component is rectilinear.

20. The method of organizing and mounting cat accessories to a cat wall of claim 17 further comprising a step of covering said base component with a fabric.
